(19) United States
(12) Patent Application Publication
(10) Pub. No.: US 2014/0076887 A1
(43) Pub. Date: Mar. 20, 2014

(54) Induction Heated Hair Styling Appliances And The Heating Unit Therefor

(71) Applicant: Tai Wah Distributors Pte Ltd, Singapore (SG)

(72) Inventor: Kok Swee TOH, Singapore (SG)

(21) Appl. No.: 13/966,284

(22) Filed: Aug. 14, 2013

(30) Foreign Application Priority Data
Sep. 18, 2012 (SG) 201206925-8
Dec. 21, 2012 (SG) 201209492-6

(51) Int. Cl. H05B 6/06; A45D 4/16

(52) U.S. Cl. CPC H05B 6/06; A45D 4/16
USPC 219/667

(57) ABSTRACT

The present invention provides an induction heating unit for heating up a hair styling appliance. The induction heating unit comprises a container defining a well that is surrounded by an induction coil winding, a controller electrically connected to the induction coil winding to operationally control a heating power; and a sensor plug disposed at the bottom on the well, the sensor plug adapted for coupling with a sensor socket on the hair styling appliance to detect at least temperature of the hair styling appliance through a temperature sensor, wherein the controller operationally controls a heating power based at least on the temperature detected through the temperature sensor. A method of heating up a hair styling appliance is also provided.

### FIELD OF THE INVENTION

The present invention generally heated brush. More particularly, the present invention relates to a heated brush for hair styling and a heating unit for heating up the heated brush.

### BACKGROUND

Hair styling often requires heating up hair to style it. Depending on the used, different hair styling appliances have different ways of heating up. For example, curling tongs and hair straightening device, such devices requires electrical power to continuously heating up the heating elements thereon. Most commonly, the electrical power is supplied through a power cord/wire connected thereto. Such power cord/wire often get in the users' way when they operate these appliances.

Another hair styling appliance includes thermal brush that is commonly used in conjunction with a hair blower/dryer. The hair blower/dryer serves as a heat source to heat up hair as well as the thermal brush operationally. It is recognized that ordinary users may face challenges to operate several appliances simultaneously. Further, such appliances do not retain heat within the appliances itself; as soon as the hair blower stops blowing heated air to the thermal brush, it cools down very quickly.

### SUMMARY

There is a desire to provide user a cordless and handheld appliance that is easy and convenience to use. Preferably, the cordless and handheld is easy to operate, fast heating up,

In one aspect of the present invention, there is provided a heated hair-styling appliance for styling hair. The hair-styling appliance comprises a heated head having an outer shell covering at least part of the surface thereof, and an inner heat source core disposed within the inner part of the heating head, a handle attached to a distal end of the heating head. The hair-styling appliance works in conjunction with an independent induction-heating unit to heat up the inner heat source core, wherein the heat source core supplies heat to heat up the outer shell for styling hair after it is being heated.

In one embodiment, the handle is detachable from the heating head.

In another embodiment, wherein the outer shall is made up of heat conductive material. Possibly, the outer shell is cover by a thermal insulation layer, such as ceramic coating or any thermal insulation material. In yet another embodiment, the inner heat source core is made up of a thermal conducting material, such as ferrous metal.

In a further embodiment, the hair-styling appliance is a thermal brush. The thermal brush may have the outer shell covered with a thermal insulation layer, and bristles are formed on the thermal insulation layer.

In yet a further embodiment, the hair-styling appliance is a curling tong or a hair-straightening iron. The heating head may further define an aperture, wherein the aperture provides access into the inner part of the heating head.

Further, the heating head further comprises a sensor port adapted for coupling with a sensor plug of the independent heating unit to detect. It may further comprise a temperature sensor disposed in the inner part of the heating head and electrically connected to the sensor port, wherein the temperature sensor is operable to send signals to the independent heating unit through the sensor port coupling with a sensor plug of the independent heating unit.

Yet, the hair styling appliance may further comprise an identifier attaching for identifying a type of the hair styling appliance through the independent heating unit. The identifier may be a resister connecting to the sensor port, wherein each type of the hair styling appliances can be identified through one fixed resistance value.

In another aspect of the present invention, there is provided a hair styling appliance comprises an induction heating unit having a container, the container defines a well that is surrounded by a induction coil winding, the induction coil winding is connected to a circuitry operationally generates electromagnetic induction within the well through the coil winding and the aforesaid hair-styling appliance. The hair-styling appliance is heated up within the well through the electromagnetic induction for usage.

In yet a further aspect of the present invention, there is provided an induction heating unit for heating up a hair styling appliance. The induction heating unit comprises a container defining a well that is surrounded by an induction coil winding, a controller electrically connected to the induction coil winding to operationally control a heating power; and a sensor plug disposed at the bottom on the well, the sensor plug adapted for coupling with a sensor socket on the hair styling appliance to detect at least temperature of the hair styling appliance through a temperature sensor. The controller operationally controls a heating power based at least on the temperature detected through the temperature sensor.

In one embodiment, the temperature sensor is disposed on the sensor plug. In an alternative embodiment, the temperature sensor is disposed on the hair styling appliance and electrically connected to the sensor socket, whereby the controller is operable to receive signals from the temperature sensor when the sensor socket is coupled with the sensor plug.

In a further embodiment, the temperature sensor may be a negative temperature coefficient (NTC) thermistor or a thermocouple device. Further, the sensor plug comprises a multi-channel plug.

In another embodiment, the controller further detects a type of hair styling appliance when the sensor socket is coupled with the sensor plug through an identifier electrically connected to the sensor socket.

In yet a further aspect, there is provided a method of heating a hair styling appliance through an induction heating unit. The method comprises placing a hair styling appliance into an induction heating unit with a sensor socket on the hair styling appliance coupled with a sensor plug disposed on the induction heating unit; detecting temperature of the hair styling appliance through a temperature sensor; and controlling a heating power based at least on the temperature detected through the temperature sensor.

In one embodiment, the method further comprises detecting a type of the hair styling appliance through an identifier connected to the sensor socket of the hair styling appliance, wherein the controller operationally the heating power based on the type of the appliance detected.

### BRIEF DESCRIPTION OF THE DRAWINGS

Preferred embodiments according to the present invention will now be described with reference to the figures accompanied herein, in which like reference numerals denote like elements;

FIG. 1A illustrates an overall appearance of a heating unit in accordance with one embodiment of the present invention;

FIG. 1B illustrates the heating unit of FIG. 1A, with a portion of the housing cut out, exposing the components mounted within the heating unit;

FIG. 1C illustrates an induction-heating pot in accordance with another embodiment of the present invention;

FIG. 1D illustrates a sensing rod in accordance with one embodiment of the present invention;

FIG. 2A illustrates a schematic diagram of the circuitry of the heating unit in accordance with one embodiment of the present invention;

FIG. 2B illustrates a control panel of a heating unit in accordance with one embodiment of the present invention;

FIG. 3 shows an operation flow of the induction-heating unit of FIG. 1A in accordance with one embodiment of the present invention;

FIG. 4 illustrates a thermal hairbrush in accordance with one embodiment of the present invention;

FIG. 5A illustrates a thermal hairbrush in accordance with another embodiment of the present invention;

FIG. 5B illustrates a thermal hairbrush in accordance with an alternative embodiment of the present invention;

FIG. 5C illustrates a thermal brush in accordance with yet another embodiment of the present invention;

FIG. 6 illustrates a curling iron in one embodiment of the present invention; and

FIG. 7 illustrates a hair-straightening appliance in accordance with one embodiment of the present invention;

FIG. 8 illustrates schematically a configuration of temperature measurement assembly in accordance with one embodiment of the present invention;

FIG. 9A illustrates temperature measurement assembly in accordance with an alternative embodiment of the present invention;

FIG. 9B illustrates a temperature measurement assembly in yet another alternative embodiment of the present invention; and

FIG. 9C illustrates schematically a temperature measurement assembly in accordance with a further embodiment of the present invention.

### DETAILED DESCRIPTION

Embodiments of the present invention shall now be described in detail, with reference to the attached drawings. It is to be understood that no limitation of the scope of the invention is thereby intended, such alterations and further modifications in the illustrated device, and such further applications of the principles of the invention as illustrated therein being contemplated as would normally occur to one skilled in the art to which the invention relates.

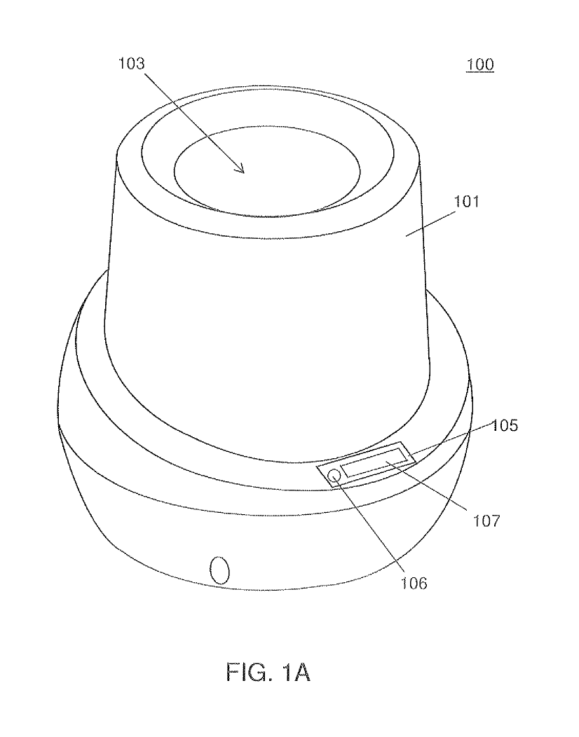

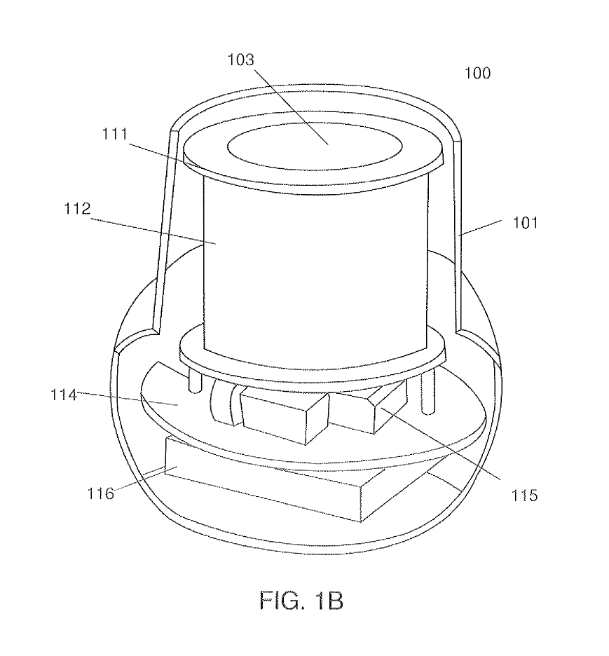

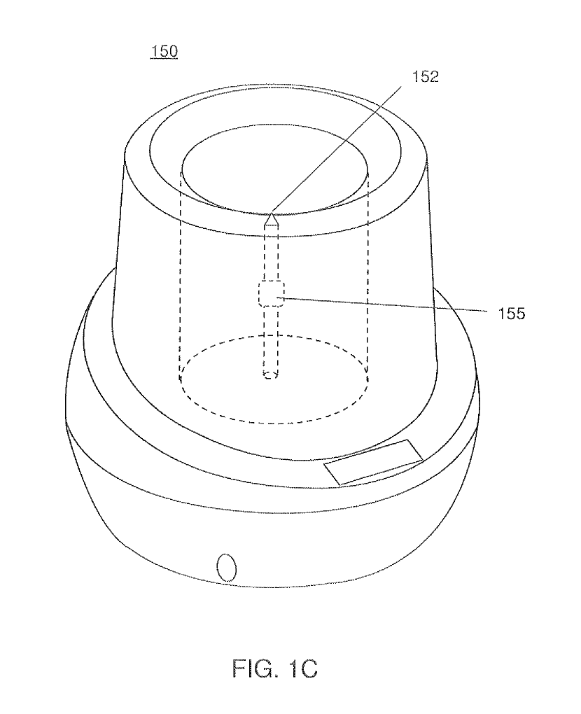

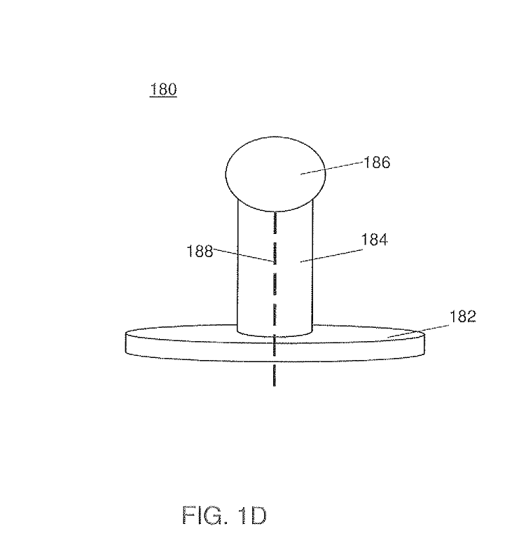

FIG. 1A illustrates an overall appearance of a heating unit 100 in accordance with one embodiment of the present invention. The heating unit 100 is adapted to heat up a thermal brush (not shown in FIG. 1A). Preferably, the heating unit 100 is adapted with induction heating assembly for heating up the thermal brush placing therein. The heating unit 100 includes a housing 101 for accommodating components therein. An upper portion of the housing 101 incorporates a well 103 adapted for loading the heated brush. The size and depth of the well 103 is catered to be large enough for loading multiple sizes thermal brushes. The heating unit 100 is adapted for heating up thermal brush that generally adapted with handle. It is also desired that the well is adapted to receive only the brush portion of the thermal brush, while exposing the handle for outside of the heating unit for handling. Accordingly, a thermal brush can easily be placed into the well 103 so that the heated brush can be heated through the heating unit 100 for subsequent usage. Further, the thermal brush, regardless of the sizes, can be effortlessly placed or dropped the heated brush into the well 103 at any orientations while the heating unit is heating up the heated brush within the cavity of the well 103. A control panel 105 can be disposed on an external surface of the housing 101. The control panel 105 may further include a button 106 and a display screen 107 for providing the necessarily operation control. The button 106 may be an on/off switch, or multi-triggering button for controlling the operation of the heating unit.

It is understood that an induction heating unit is desired in this embodiment as it offers quick heat up time and it allows the hair styling appliances to be reheated with minimal or no downtime. However, other heating unit may be desired without departing from the scope of the present invention.

FIG. 1B illustrates the heating unit 100 of FIG. 1A, with a portion of the housing 101 cut out, exposing the components mounted under the housing 101. The heating unit 100 comprises two parts, an upper part that includes the well 103, and a bottom part that accommodates the circuitry of the heating unit 100.

The upper part of the heating unit 100 includes the well 103, a winding roller 111 and a coil 112. The winding roller 111 is an inner cylinder adapted to wrap around the circular surface of the well 103 within housing 101. The winding roller 111 facilitates a means for supporting the coil 112, such that the coil of wire, preferably copper wire, can be disposed around the perimeter of the winding roller 111.

The coil 112 is electrically connected to the circuitry of the heating unit 100, which is mounted beneath the upper part of the heating unit 100. The circuitry comprises a PCB board 114 and components adapted for driving the coil 112 to generate the electromagnetic induction to heat up the heated brush. Beneath the PCB board 114, there is further provided a heat sink 116 attached to the components that operationally produce heat. In another embodiment, the heating unit 100 may further provide a fan for increase the heat dissipation efficiency.

FIG. 1C illustrates an induction-heating pot 150 in accordance with another embodiment of the present invention. The induction heating pot 150 has a similar configuration as that of the induction-heating unit 100. The induction heating pot 150 further comprises a guiding pole 152 extending upwardly from the bottom of the well. The guiding pole 152 has a tapered end and along the length of the guiding pole 152, there is provided a thermal sensor 155. The induction heating pot 150 works in conjunction with a thermal brush or hair-styling appliances adapted with a corresponding slot configured for receiving the guiding pole 152. Preferably, the guiding pole 152 is supported through a flexible member allowing the guiding pin to be able to swivel in all direction.

FIG. 1D illustrates a sensing rod 180 in accordance with one embodiment of the present invention. The sensing rod 180 has substantially the same functions the guiding pole 152 of FIG. 1C, i.e. providing a sensor for sensing the temperature of the thermal brush that is placed within the unit for heating. The sensor is a contact type of sensing device. The sensing rod 180 comprises a base 182, a flexible rod 184, a sensor tip 186 and a wire 188. The base 182 is provided for supporting the entire sensing rod 180 and to attach it within the well of the heating unit. The flexible rod 184 is attached the base 182 at one end, and extending upwardly at another free end. The sensor tip 186 is attached at the free end of the flexible rod 184 and the wire 188 is electrically connected to the sensor tip 186 and extending downwardly within the cavity of the rod, through the base of the well and electrically connecting to the heating unit's controller.

The sensor tip 186 is being made in round shape for easily coupling with the thermo brush. It can also be made in any other shape that corresponds to the configurations of the thermal brush for easy and effortless coupling. Preferably, the sensor tip 186 is made up of material that is would not be heated up during the operation of the heating unit. For example, aluminium can be selected for the sensor tip 186 on an induction-heating unit.

The flexible rod 184 can be made up of any flexible material, such as silicon, or even spring. It is desired that rod 184 can be band in omni-directions, which standing still upright when it is left untouched.

When in used, the thermal brush or the associated hair styling apparatus is placed within the well of the induction-heating unit with the sensing rod 180 couples with the thermal brush. Correspondingly, the thermal brush has a coupling means for receiving the sensing rod 180 for sensing temperature of the thermal brush. Specifically, the inner core of the thermal brush. It is desired that the sensing rod 180 and the coupling means are configured in any such way that user may effortlessly insert the thermal brush into the well of the induction-heating unit for heating. In one embodiment, the thermal brush includes an aperture on the top of the brush, wherein coupling and inserting the sensing rod 180 into the aperture allowing the sensing rod 180 to come into contact with the inner core of the thermal brush in order to sense the temperature of the thermal brush.

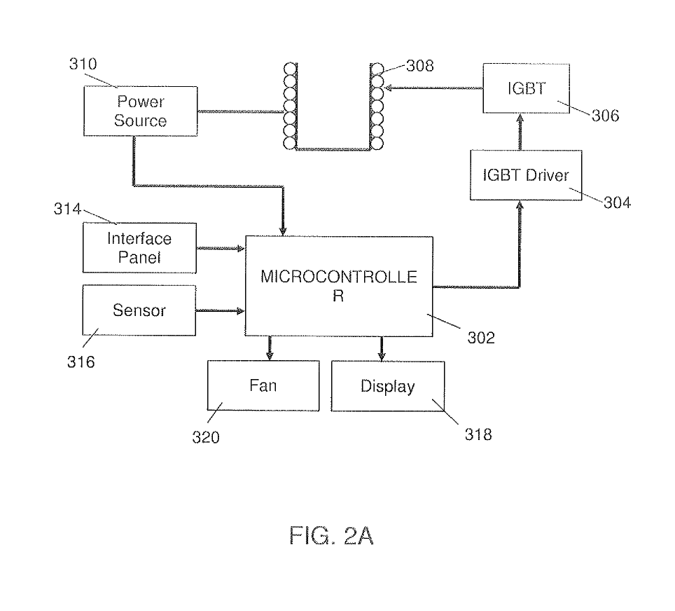

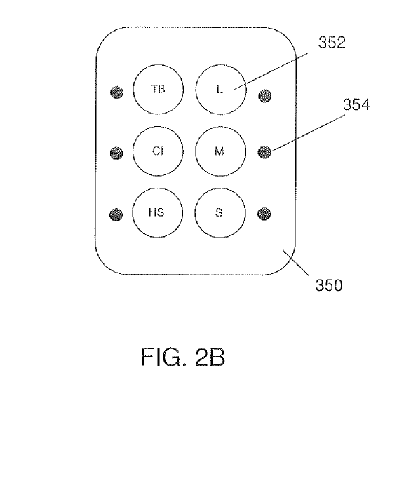

FIG. 2A illustrates a schematic diagram of the circuitry of the heating unit in accordance with one embodiment of the present invention. The circuitry 300 includes a microcontroller 302, an insulated gate bipolar transistor (IGBT) driver 304, one or more IGBT 306, a power source 310, an interface panel 314, sensors 316, and optionally a fan 320. The power supply 310 operationally supplies power to the entire heating unit. It may be a multi-voltage power supply. Depending on the design and specification, the power supply may further include a switch mode power supply (SMPS) circuit, to transforms the DC bus voltage into several different DC low voltage outputs.

The microcontroller 302 is adapted for controlling the entire operations and processes of the induction-heating unit. The microcontrollers 302 suitable for the induction heating equipment can be any suitable microcontroller available in the market.

The IGBT 306 is the main power component and is provided to drive the coil 308 that are winded around the well of the induction heater. The IGBT 306 is driven by the IGBT driver 304 that provides a voltage transfer interface between the microcontroller 302 and the IGBT 306. It is well known in the art that, when desire, the IGBT 306 can be replaced several bipolar transistors.

The microcontroller is further connected to the interface panel 314 for receiving control input from user and display some operating status to the user. The interface panel 314 may include switches and a display panel. User may control the operations of the induction heater through the switches provided on the control panel, and monitor the operating status through the display panel. The interface panel 314 may further include LED lights for showing the operating status.

The sensors 316 include a thermal sensor for detecting the temperature within the well of the induction heater, or more specifically the temperature of the thermal brush heated therein. These sensors detect the necessary operating status automatically, and the microcontroller 302 responds according. For example, the sensor can be placed at the bottom of the well as a switch, and when a thermal brush is placed within the well and triggers the sensor, the induction heating unit would recognize so in order to carrying out further operation. This can prevent that the induction heating being turned on unintentionally without any thermal brush presents therein. In another embodiment, the sensor can be used to detect the presence of the thermal brush to automatically trigger the induction-heating unit to heat up the thermal brush as it is placed within the well of the heating unit.

For safety purpose, it would be desired that the thermal sensor be provided for detecting the heating condition. Preferably, the thermal sensor is adapted to be able to detect at least the temperature of the thermal brush. When the thermal brush is detected overheating, the induction-heating unit will cut off automatically. For example, when a heated thermal brush that has not been cooled down is placed within well, the induction heater may overheat the thermal brush. Accordingly, it is desired that the temperature of the thermal brush that is placed within the well can be detected before the induction heating operation starts.

The thermal sensor may be a thermopile, or thermopile infrared sensor or the like. It may also be thermocouples or the like. Most preferably, the thermal sensor is able to detect the temperature of the thermal brush contactlessly.

The induction-heating unit may further adapt with the fan 320 to dissipate heat during the heating operation. The heat generating components may further attach with heat sink to work in conjunctions with the fan to effectively dissipate the heat operationally.

It is understood to a skilled person that the above circuitry is illustrated by way of example only, not limitations. There are many other suitable configurations that can be adapted for the induction-heating unit. Preferably, the induction-heating unit shall be able to heat up the heated element of the thermal brush to a desired working temperature suitable for practical hair styling. The thermal sensor can be adapted to control or cut off heating to prevent overheating.

The induction heater is heated by controlling the coil power. To control it, a synchronous signal is needed to be detected.

For safety protection, the induction may provide an overvoltage (OV) and overcurrent (OC) detection means. Operationally, when the induction heater is running, it may generate an over voltage or a high level of voltage noise created by the repeatedly switching (i.e. on/off) IGBT 306, which may damage the IGBT 306. A potentiometer OV may be facilitated to the microcontroller 302 to regulate the voltage. When current flowing through the IGBT 306 is higher than the expected current, the IGBT 306 can also be damaged. A current transformer can be adapted to prevent OC.

FIG. 2B illustrates a control panel 350 of the heating unit in accordance with one embodiment of the present invention. The control panel 350 provides buttons 352 that allow various controls on the heating unit to heat up various type of hair styling apparatus that can also be provided in various sizes, which require different temperature controls. The hair styling appliances may include thermal brushes (TB), curling iron (CO, hair-straightening clamps (HS) and etc. The sizes available may be labeled large (L), medium (M) and small (S), or the like. Such various controls are desired because different hair styling appliances with different sizes may require different heating level and time. Each time when a hair styling appliances is being heated up, user may require to select both the type of hair styling appliances and the size of the appliances. An LED light 354 maybe provided adjacent to the respective buttons 352 to indicate what have been selected.

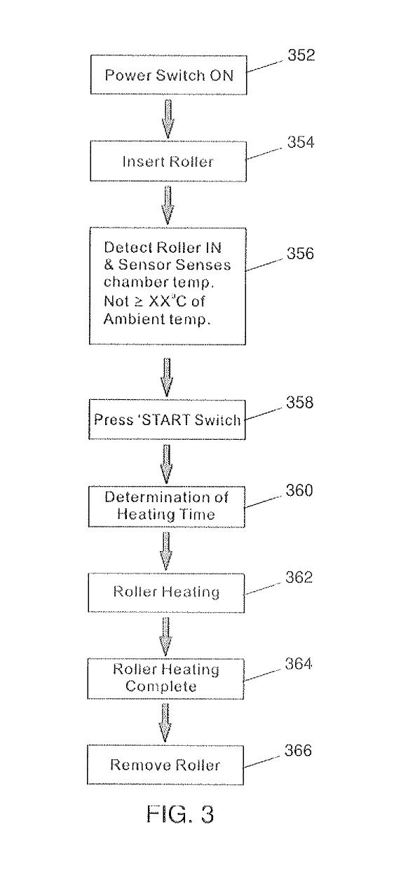

FIG. 3 shows an operation flow of the induction-heating unit of FIG. 1A in accordance with one embodiment of the present invention. The operation starts with pressing a power switch to turn on the induction-heating unit at step 352. At this stage, the induction-heating unit is placed at a standby mode. At step 354, the thermal brush can be inserted into the well of the induction-heating unit. Once the thermal brush is placed in the induction-heating unit, the induction-heating unit will detect the presence of the thermal hairbrush at step 356. The presence of thermal hairbrush will trigger a thermal sensor to detect whether the temperature of the thermal hairbrush is detected to be higher than a predefined level. If the detected temperature is higher than the predefined level, the induction-heating unit will not function to heat up the thermal hairbrush. Such detection is provided to prevent overheating. If the detected temperature is below the predefined level, the LED light indicator may light up to indicate that the induction-heating unit is ready for operation. At step 358, the user may press a start button to start heating up the thermal hairbrush. At step 360, the induction-heating unit may determine the heating time require. The time determination may be based on the temperature detected at step 356, or it triggers the sensor to detect the temperature again after the start button is pressed. The thermal hairbrush is being heated up in step 362, and once the heating operation is completed at step 364, users may remove the thermal hairbrush from the induction-heating unit at step 366 for hair styling.

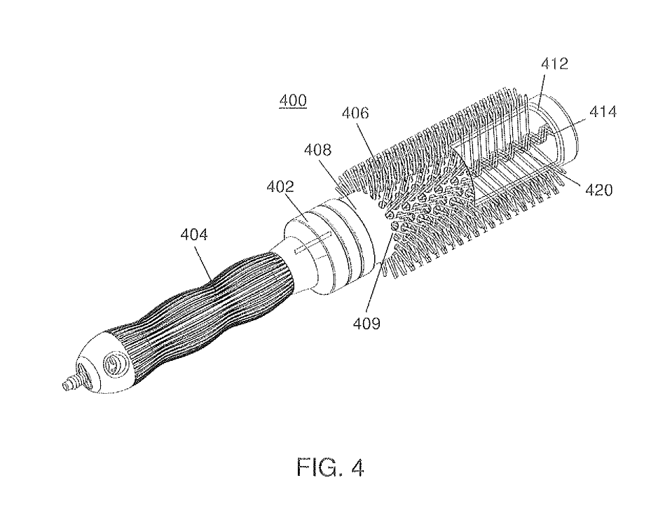

FIG. 4 illustrates a thermal hairbrush 400 in accordance with one embodiment of the present invention. The thermal hairbrush 400 is adapted with a capability of storing and self-releasing heat without any power source or external heat source. The thermal hairbrush 400 is adapted for heating up through induction heating unit, and once heated up it can be used immediately out from the induction-heating unit. The thermal hairbrush 400 has a brush head 402 with a brush handle 404 thereto for allowing users to handle the thermal hairbrush 400. The brush head 402 is shown in a preferred embodiment as a round vented brush of a generally elongated cylindrical shape. However, one skilled in the art should appreciate that the thermal hairbrush 400 may be used with a round brush, a cylindrical shaped brush, a flat hairbrush, a paddle brush, a spinning brush, a half round brush, a vent brush with a specific configuration adapted to suit the present application. When in use, user may hold on to the brush handle 404 and place it into the well of the induction-heating unit of FIG. 1A. Once it is heated, the heated thermal hairbrush 400 may assist with curling the hair being brushed with the heat emitted therefrom. The advantage of the thermal hairbrush 400 is: once heated, it can be use immediately. It also does not require external power source to heat it up, therefore, no cable is adapted thereon, therefore, it is easier to handle.

Referring back to the FIG. 4, the brush head 402 may be formed in a variety of diameters. Relatively narrow diameters are especially effective for creating curls while conversely relatively larger diameters create looser curls. The brush head 402 is extends about half way on the heated hairbrush 400 from an end to about a midpoint on the thermal hairbrush 400. The brush head 402 has a length suitable to comb or style hair in a comfortable manner and further to have a adequate number of bristles 406 disposed in surrounding fashion thereon. As illustrated by the thermal hairbrush 400, the bristles 406 are extended from the inner side of the brush head 402.

The brush head 402 has a outer shell 408 that disposed around the brush head 402 in concentric relation to the brush head 402. The outer shell 408 further defines through holes 408, through which, the bristles 406 extend outwardly from the inner space of the brush head 402.

Still referring to FIG. 4, the thermal hairbrush 400 is being shown with a cut out portion exposing the inner part of the brush head 402 and the constructions of the outer shell 408. Generally, the outer shell 408 is adapted as a heat retainer. The outer shell 408 is made up of two layers 412, 414. The layer 412 is made up of thermal insulation material and the layer 414 is made up of thermally conductive material. For layer 412, materials such as ceramic material, polymer may be adapted. In an alternative embodiment, it may also be a thin layer of thermally insulation coating coated on top of the layer 414. The layer 414 on the other hand, is made up of thermally conductive material such as metal, copper, aluminum, or any other thermally conductive material known in the art. Through the cut out portion, it can be seen that the thermal brush 400 further comprises a heat source core 420, of which, the bristles are extended therefrom. Preferably, the heat source core 420 is also made up of heat conducting materials. More preferably, the heat source core 420 can be made up of ferrous metals or alloys. The preferred materials for the heat source core 420 shall be easily heated up through induction heating, and preferably, the material used is able to retain heat as long as possible. The heat source core 420 may further be quoted with heat retaining coating, such as ceramic coating.

Operationally, the thermal brush 400 is placed in an induction-heating unit, such as the one illustrated in FIG. 1A. Once the induction-heating unit is turned on, the thermal brush 400 is being heated up through electromagnetic induction. More specifically, the conducting materials, i.e. the outer shell 408 and the heat source core 420 will be heated up to a desired temperature. The induction heating may be stopped through a timer, and once the time is up and the thermal brush 400 is heated up, it is ready to be used. When in used on hair, the outer shell 408 heats up the hair directly because it is in direct contact with hair. The thermally conductive layer 414, which is heated up by the induction-heating unit, releases the heat through the thermal insulation layer 412 slowly. The thermal insulation layer 412 serves as a thermal retainer for holding the heat onto the thermally conductive layer 414 as long as possible.

Similarly, once the heat source core 420 is heated up by the induction heating unit, it serves as a heat source to the thermal brush 400 for supplying heat continuously to heat up the outer shell 408 as it looses heat to the ambient operationally.

In yet another embodiment, the thermal insulation material can be a layer of insulating coating, for example, ceramic coating. Such insulation material can also be applied onto the heat course core 420, in accordance with another embodiment of the present invention.

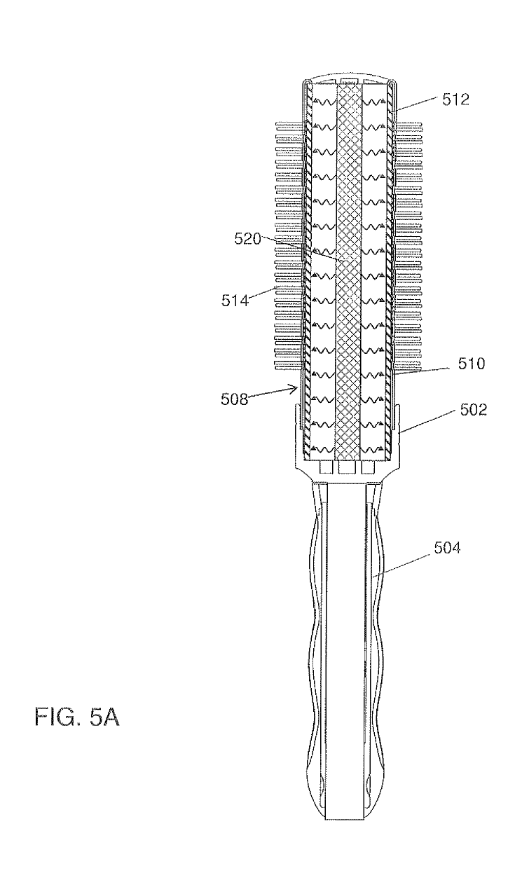

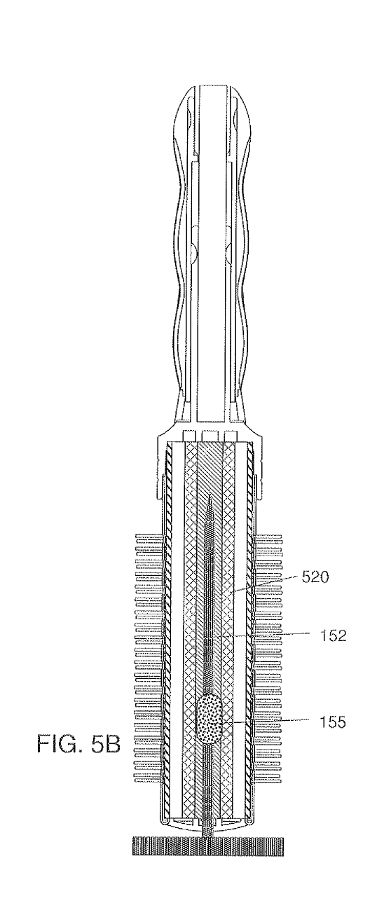

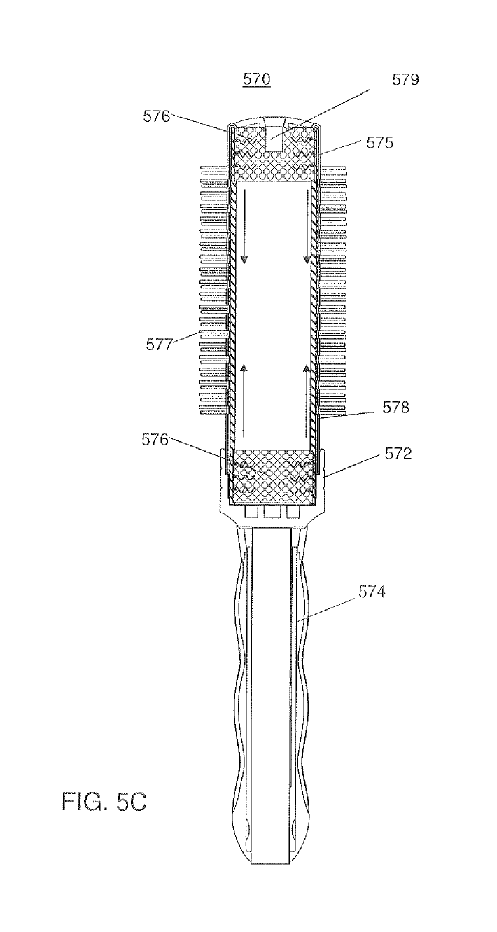

FIG. 5A illustrates a thermal hairbrush 500 in accordance with another embodiment of the present invention. The thermal hairbrush 500 comprises a brush head 502 with a brush handle 504 attached thereto at one end. The brush head 502 has an outer shell 508 that disposed around the brush head 502 in concentric relation to the brush head 502. The outer shell 508 is formed by two layers, a sleeve 510 and a metal layer 512. The metal layer 512 is an inner cylinder defining an inner cavity. The metal layer is made up of thermal conductive material, such as copper, aluminum or the like. Preferably, it is made up of a material that can be heated up through induction heater. The sleeve 510 is an outer layer wrapping around the metal layer 512. Bristles 514 of the thermal hairbrush 509 are extending directly from the sleeve 510. The sleeve 510 together with the bristles 514 are made up of thermal insulation material, for example, nylon.

Within the cavity of the inner cylinder, the brush head 502 is further provided with a heat source core 520 disposed along the concentric axis of the brush head 502. In this embodiment, the heat source core 520 is configured as a solid component, though it is possible to make the heat source core 520 with a hollow cylinder. Similarly, the heat source core 520 is made up of thermal conducting material; more preferably, it is made up of material that can be heated up through induction heating.

As shown in FIG. 5A, the heat source core 520 is disposed within the cavity spaced apart from the sleeve 510. In another embodiment, it is possible that the heat source core 520 can be made as an inner cylinder disposed beneath the metal layer 512, with or without space. In yet a further embodiment, the heat source core 520 may also be covered by a thermal insulating material (i.e. between the metal layer 512 and the heat source core 520) aims for slowing down the heat transfer from the heat source core 520 to the metal layer 512.

Operationally, the thermal hairbrush 500 is heated up with a same or substantially the same way as the thermal hairbrush 400, and as the thermal hairbrush 500 does not have holes on the outer shell as the thermal hairbrush 400, it is expected that the heat can be retained longer within the thermal hairbrush 500.

Although, the outer shells shown above are completely surrounding the respective brush head, alternatively the outer shells may only surround a radial portion of the brush head such as three quarters of the brush head, half of the brush head or a quarter of the brush head.

Further, the brush heads of the thermal hairbrushes illustrated above are fixed to the handle. In other embodiments, these thermal hairbrushes may be adapted with the brush head detachable from the handle, when desire. In such case, the handle may adapt a quick release latch for securing the brush head onto the handle.

FIG. 5B illustrates a thermal brush in accordance with an alternative embodiment of the present invention. The thermal brush is substantially the same as the thermal brush 500 except that the heat source core 520 is made a hollow core and the top of the thermal brush is adapted with an aperture leading up to the hollow space of the hollow core. Such configuration allows the thermal brush to be placed into the induction heating pot through inserting the guiding pole 152 into a hollow space of the hollow heat source core 520 as shown in FIG. 5B. Preferably, the thermal sensor 155 is made slightly bigger than the diameter of the guiding pole 152 to give a tight fit when it is inserted into the heat source core of the thermal brush. Such configuration allows the thermal sensor to effectively measure the temperature of at least the heat source core 520.

The guiding pole 152 can further be adapted as a sensor to detect the presence of the brush in the well of the heating unit as the guiding pole 152 is inserted into the thermal brush.

FIG. 5C illustrates a thermal brush 570 in accordance with yet another embodiment of the present invention. The thermal brush 570 has exactly the same exterior configuration as the thermal brush 500 of FIG. 5A, i.e. it comprises a brush head 572 attaching to a brush handle 574. The brush head 572 has an outer shell 578 disposed around the brush head 572 covering with bristles 577. Under the outer shell 578 wrapped a cylinder 575 that made up of heat conductive material, more preferably, induction heatable material. Two extreme ends of the cylinder are respectively disposed with a heat core 576 with a direct contact with the cylinder. Both heat cores are disposed in the inner part of the thermal brush. The one on the top distal end of the thermal brush is covered by a cap. The cap is preferably made by heat insulated material to minimize heat from dissipating from the top. The heat core 576 is also made up of heat conductive material, more preferably, induction heatable material. The two heat cores 576, similar to the heat source core 520, is provided in the thermal brush is operable to supply heat continuously after it is being heated up. Accordingly, it places no limitation on the shapes and sizes required for the heat cores 576 as long as they are able to function as a heat reservoir to store heat and able to supply the heat graduatedly to the cylinder. It is further understood that one of the heat core 576 would be sufficient to deliver the heat required, but two may work better in supplying the heat more consistently.

It is also understood to a skilled person that there can be many variations to configure the heat core 576, for example, the heat core may be a hollow body or a solid piece that fills up the inner part of the brush head. It is well understood that the more material provided, more heat can be stored, but it also compromises the weight. It is therefore desired that any configurations of the hair styling appliances according to the present invention shall consider the balance with the heat storage capacity and the appliances' weight. But it imposes no limitations on the configurations and designs on the appliances.

Still referring to FIG. 5C, the cap for covering the heat core 576 on the top may further define an aperture, and correspondingly, the heat core 576 defines a channel 579. The channel 579 is provided for receiving a sensor that when inserted, gets into direct contact with the heat core 576 so that the temperature of the heat core can be measured.

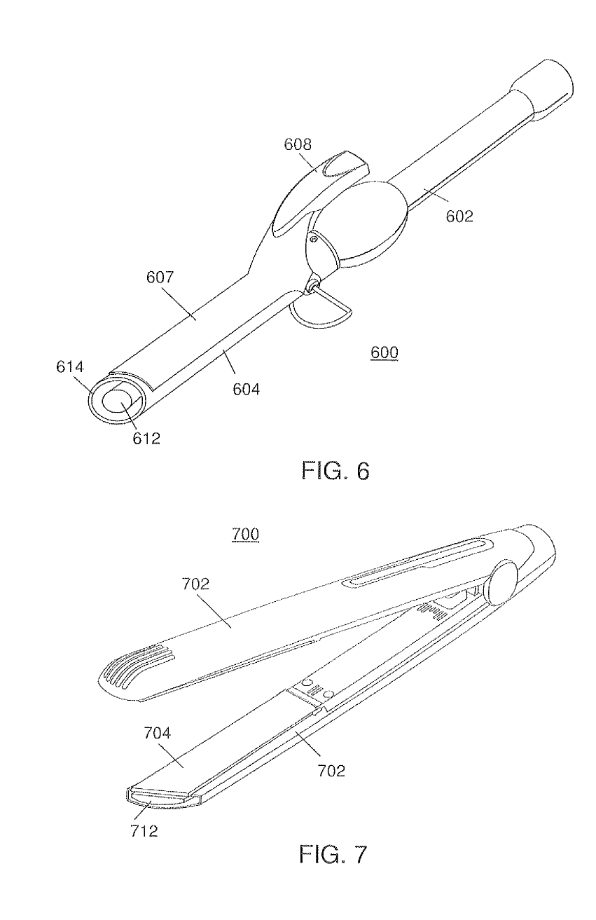

FIG. 6 illustrates a curling iron 600 in one embodiment of the present invention. The curling iron 600 comprises a handle 602 and an heating rod 604 attached to the handle 602. The curling iron 600 further has a clamp 606 pivoted at the proximal end of the handle 602 with a clamping plate 607 covers a portion of the heating rod 604, and a actuator 608 on the other side of the pivot projecting over the handle 602.

In FIG. 6, the front end of heating rod 604 is cut out to show the inner configurations of the heating rod 604. As shown, the heating rod 604 includes a heat source core 612 and a heating shell 614. The heating shell 614 forms the outer shell of the heating rod 604. When in used, it is directly contacting the hair to style the hair. The heating shell 614 may be coated with a layer of thermal insulating material for prolonging the heating process. The heat source core 612 is a concentric tubular component that disposed within the heating shell in a telescopic manner. When possible, a space may be provided between the heat source core 612 and the heating shell.

It is to be noted that the curling iron 600 does not require any power source to operate, therefore, no cord is attached thereto.

FIG. 7 illustrates a hair-straightening appliance 700 in accordance with one embodiment of the present invention. The hair-straightening appliance 700 includes two opposing tongs 702 that are being hinged together at one distal end. Opposite the hinge, the opposing tongs 702 holds a heating plate 704 on each tong 702. The heating plate 704 is removable flow the tong 702. The heating plate can be a flat panel for straightening hair, or a profiled panel defining zigzag profile for crimping hair.

As shown in FIG. 7, the front end of the lower tong 702 is cut out to show the inner configurations of the hair-straightening appliance 700. As shown, the tong 702 has a heat source core 712 disposed beneath the heating plate 704 with a space apart.

It is understood that the hinge of the two opposing tongs 702 can be configured at the middle, i.e. class 2 lever, in accordance with another embodiment of the present invention.

When in used, the curling iron 600 and the hair-straightening appliance 700 illustrated above can be placed into an induction-heating unit for heating up. Once it is heated up to a desired temperature, it can be remove from the induction-heating unit for immediate usage. The outer plate or shell directly heats up the hair as it is in direct contact with the hair. The inner core, which was also heated up through the induction heating unit, dissipates it heat slowly to the outer plate or shell, thereby prolonging the heating capability.

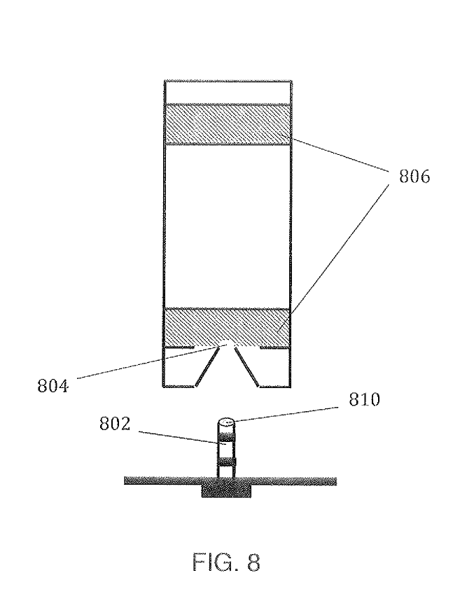

FIG. 8 illustrates schematically a configuration of temperature measurement assembly in accordance with one embodiment of the present invention. The temperature measurement assembly comprises a sensor plug 802 and a sensing port 804. The temperature measurement assembly is adapted on a thermal brush adapting two heat cores 806 that are disposed at the two ends of the brush head similar to that of FIG. 5C. The sensor port 804 can be simply an opening defining at the top end of the thermal brush to expose the heat core 806. The heat core 806 may further defines a small depression for receiving the sensor plug 802. The sensor plug 802 has a thermal sensor 810 disposed on its tip in a manner that when the sensor plug 802 is inserted into the brush head through the sensing port 804, the thermal sensor 810 is in contact with the heat core 806. The thermal sensor 810 can be any thermocouple, such as a K-type thermocouple device electrically connected to the control circuitry or PCB board of the heating unit. Such configuration allows the thermal sensor 810 to operationally come into contact with the one of the thermal core 806 of the thermal head to measure the temperature of the thermal core 806. Once the temperature of the thermal core 806 is obtained, the temperature of the outer conductive shell that is in contact with the two thermal cores can be estimated through the control circuitry the heating unit.

In a further embodiment, the temperature measurement assembly may further comprise a sensor to detect the present of brush as the sensor plug 802 is inserted into the sensing port 804. The sensor can simply be two open-circuit terminals on the sensor plug 802, and a jumper disposed at the opening of the sensor port 804, and when the sensor plug 802 is inserted into the sensing port 804, the jumper closes the two terminals to indicate that a thermal brush is inserted into the heating unit.

It is apparent to a skilled person that by knowing at least the size and material of the heat core 806 to be measured, the temperature of the outer conductive shell can be readily estimated. It is presumed that the outer conductive shell is at least at the same or lower temperature than the heat core 806.

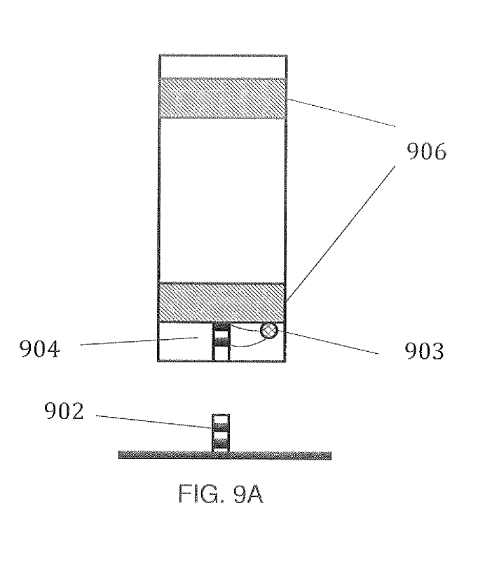

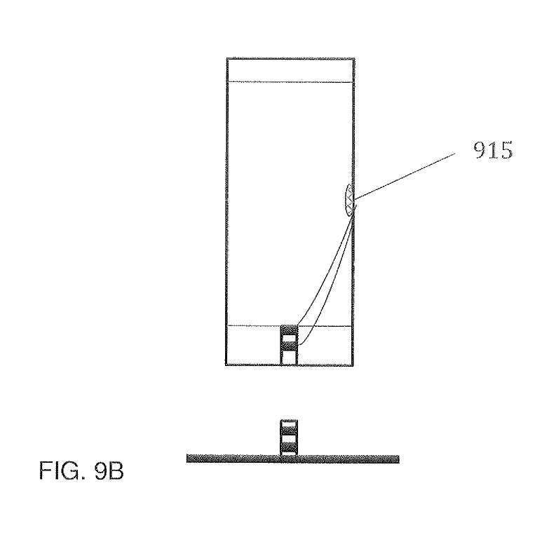

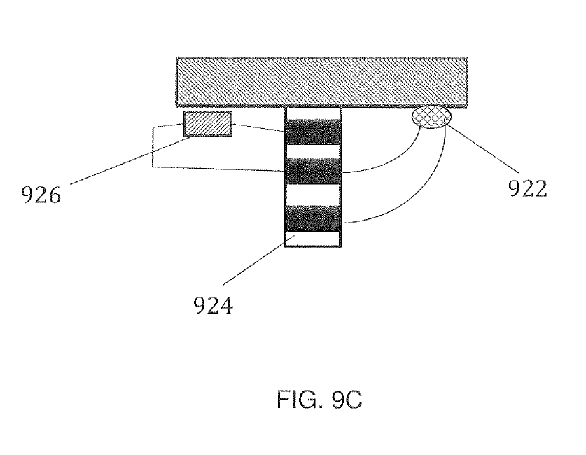

FIG. 9A illustrates temperature measurement assembly in accordance with an alternative embodiment of the present invention. The assembly, too, is adapted on a thermal brush adapting two heated cores 906 that are disposed at the two ends of the brush head similar to that of the FIG. 5C. The temperature measurement assembly comprises a port 904 and a plug 902, and a sensor 903. Both port 904 and the sensor 903 are disposed on the brush head while the plug 902 is disposed on the heating unit and electrically connected to the control circuitry or PCB board of the heating unit.

In this embodiment, the sensor 903 is strategically attached to one of the heat cores 906 and electrically connected to the port 904. The sensor 903 can be any thermal sensor, such as a negative temperature coefficient (NTC) thermistor, or the like. The port 904 provides a socket for receiving the plug 902. The port 904 and the plug 902 may be a multi-channel connector adapted for electrically coupling to each other, which allows the sensor 903 to send signals to the control circuitry when the plug 902 is plugged into the port 904. The multi-channel connector can be a phone-connector, TRS/TRRS connectors or the like.

FIG. 9B illustrates a temperature measurement assembly in yet another alternative embodiment of the present invention. The temperature measurement assembly is substantially the same as that of the FIG. 9A except that the sensor 915 is disposed on the heat conducting shell of the brush head directly, rather than the heat core, so that the temperature of the heat conducting shell can be measured directly.

FIG. 9C illustrates a temperature measurement assembly of a further embodiment of the present invention. The temperature measurement assembly comprises a sensor 922, a multi-channel socket 924 and an identifier 926. Similarly, the multi-channel socket 924 is adapted to couple with a corresponding plug mounted on within the heating unit. The sensor 922 and the identifier 926 are electronically connected to the respective terminal of the multi-channel socket 924. The sensor 922 is attached to a heat core 928 of a hair styling appliance to detect the temperature thereof. The identifier 926 is provided to indicate the type of appliance that is inserted into the heating unit. The identifier 926 can be any device that provides a signal to differentiate one appliance to another automatically. It allows the heating unit to identify the type of appliance and thereby provide the appropriate heating power to heat up the appliance.

In one implementation, a fix value resister may be adapted to identify the type of appliance to be heated. For example, a resister value of 1KΩ can be used to indicate that the appliance is a 30 mm thermal brush, and 2KΩ to indicate that the appliance is a curling iron, and etc. Accordingly, by detecting the resistance value of the respective resistor, the heating unit is able to identify the type of the associate appliance. In this embodiment, the fix value resister is chosen because it is a very low cost and it is relatively straightforward to implement. It is readily understood to a skilled person that many other means, such as RFID tag and etc., are possible without departing from the scope of the invention.

Besides detecting the type of appliances, it is well understood to a skilled person that the identifier 926 can further be used as a presence sensor.

In an alternative embodiment, the temperature measurement assembly may comprise two or more sensors disposed within various locations of the brush head so that the temperatures of the various locations of the brush head can be taken.

While specific embodiments have been described and illustrated, it is understood that many changes, modifications, variations, and combinations thereof could be made to the present invention without departing from the scope of the invention.

1. An induction heating unit for heating up a hair styling appliance, the induction heating unit comprising:
a container defining a well that is surrounded by an induction coil winding,
a controller electrically connected to the induction coil winding to operationally control a heating power; and
a sensor plug disposed at the bottom on the well, the sensor plug adapted for coupling with a sensor socket on the hair styling appliance to detect at least temperature of the hair styling appliance through a temperature sensor,
wherein the controller operationally controls a heating power based at least on the temperature detected through the temperature sensor.

2. The induction heating unit according to claim 1, wherein the temperature sensor is disposed on the sensor plug.

3. The induction heating unit according to claim 1, wherein the temperature sensor is disposed on the hair styling appliance and electrically connected to the sensor socket, whereby the controller is operable to receive signals from the temperature sensor when the sensor socket is coupled with the sensor plug.

4. The induction heating unit according to claim 1, wherein the temperature sensor is a negative temperature coefficient (NTC) thermistor.

5. The induction heating unit according to claim 1, wherein the temperature sensor is a thermocouple device.

6. The induction heating unit according to claim 1, wherein the sensor plug comprises a multi-channel plug.

7. The induction heating unit according to claim 1, wherein the controller further detects a type of hair styling appliance when the sensor socket is coupled with the sensor plug through an identifier electrically connected to sensor socket.

8. A method of heating a hair styling appliance through an induction heating unit, the method comprising:
placing a hair styling appliance into an induction heating unit with a sensor socket on the hair styling appliance coupled with a sensor plug disposed on the induction heating unit;
detecting temperature of the hair styling appliance through a temperature sensor;
controlling a heating power based at least on the temperature detected through the temperature sensor.

9. The method according to claim 8, further comprising detecting a type of the hair styling appliance through an identifier connected to the sensor socket of the hair styling appliance, wherein the controller operationally the heating power based on the type of the appliance detected.
